(19) United States
(12) Patent Application Publication
(10) Pub. No.: US 2008/0261187 A1
(43) Pub. Date: Oct. 23, 2008

(54) Behavior Modification Bracelet With Quantity Indicators

(76) Inventor: Kaleb Pierce, Lehi, UT (US)

Correspondence Address: ABSOLUTE TECHNOLOGY LAW GROUP LLC, 135 W. WELLS ST., SUITE 518, MILWAUKEE, WI, 53203, US

(21) Appl. No.: 12/106,198

(22) Filed: Apr. 18, 2008

Related U.S. Application Data
(60) Provisional application No. 60/912,905, filed on Apr. 19, 2007.

(51) Int. Cl. G09B 19/00; A44C 5/00; A44C 15/00

(52) U.S. Cl. 434/238; 63/1.11; 63/3

(57) ABSTRACT

A behavior modification bracelet with quantity indicator comprising a band having an outer major cylindrical surface featuring at least one metric indicia visible and at least one sliding component for marking the metric indicia.

### CROSS-REFERENCE TO RELATED APPLICATIONS

This application claims priority, in part, to U.S. Provisional Application No. 60/912,905 filed Apr. 19, 2007.

### FIELD OF INVENTION

This invention relates generally to the field of bracelets to assist a user in self-monitoring a behavior, and in particular to a durable inexpensively, manufactured device functionally adapted to track a specific behavior.

### BACKGROUND

There are a number of bracelets on the market which may be customized with logos, reminder messages and other text or indicia. One example of these bracelets are elastomeric compound bracelets which are massed produced are those available at http://www.reminderband.com/ and used to carry messages by celebrities such as DeeDee Trotter, Olympic Gold Medalist, and indicia for various charitable causes, public events, school functions and identification purposes.

Elastomeric compound bracelets produce virtually no known (or very rare) instances of skin irritation, and can be worn for long periods of time due to their durability, water-resistant qualities and light weight. Elastomeric compound bracelets can be sized to accommodate a variety of body weights and sizes, and differentiated with one or more colors and with text, graphics or other indicia.

Elastomeric compound bracelets are inexpensively manufactured with minimal labor costs involved. Consequently, they are often utilized as promotional items given away for promotions and events.

Elastomeric compound bracelets have been functionally adapted in the prior art to include markers or components to track time for events such as breastfeeding, U.S. Pat. No. D505,353 which describes an “Infant event monitoring bracelet”.

Elastomeric compound bracelets have advantages over calendars, journals, calculators and related devices to assist in tracking or remembering events.

Often, in modifying behaviors and developing good habits (e.g., eating, exercise, breaking a cycle of addictive behavior) it is necessary for an individual to continuously quantify and track a behavior related metric (e.g., calories consumed) in addition to tracking time.

While devices such as journals or digital calorie calculators (e.g., for diet and exercise) may be highly accurate, they are too expensive to be given away freely, and require a user to carry the device with them, and often require a pen, batteries or additional elements to ensure their functionality. These devices are commonly used in public places (e.g., a restaurant dinner table), and may present difficulties for the user if the user is in motion or standing. Additionally, these devices do little to serve as memory aid or provide visual psychological cues if stored in a purse or pocket. Additionally, these devices must be carried or transported by the user and can be easily lost or misplaced

It is desirable to create an inexpensively manufactured device and system which can be adapted to measure a variety of metrics related to behavior modification, provides a visual cue, and which can be used in a variety of settings.

It is further desirable to create a lightweight, durable device and system from an elastomeric compound in a manner that metric measurement components remain accurate and are not moved or dislodged despite normal physical and daily activities of a user.

### SUMMARY OF INVENTION

The present invention is an elastomeric compound bracelet and method of using an elastomeric compound bracelet to assist a user in tracking metrics needed to accomplish a personal behavior modification goal. The elastomeric bracelet is functionally adapted with one or more sliding counter pieces which can be used to track personal data and habit related metrics such as calories, consumption, nutrititive food gram consumption, diet point consumption, fluid intake, number of days spent abstaining from a behavior, number of days successfully completing a behavior, exercise goals and sessions, metrics for a financial or other budgeting goal or any other metric capable of being tracked. The device may further be used to track multiple habit related metrics simultaneously by incorporating multiple sliding pieces and reversible sliding components. The method and system may further include educational and/or reference components to assist the user in correctly calculating the metrics measured by the bracelet.

### GLOSSARY

As used herein, the term “grams” means tracked nutritive food values such as fat, saturated fat, fiber, carbohydrates, cholesterol, sodium, potassium, protein, minerals as well as point systems assigned to any combination thereof.

As used herein, the term “diet points” is a measurement with the Weight Watchers® diet system calculated based fat, calories and fiber content of food.

As used herein, the term “days of abstaining” refers to the number of days a user has abstained from a behavior or activity such as consuming alcohol, drug or other abusive subject, self-injuring behavior, abstaining from eating particular foods, abstaining from angry or violent behavior or any other behavior to which a plan of behavior modification is directed. Days of abstaining may or may not be consecutive.

As used herein, the term “instances of abstaining” refers to the number of times that user has abstained from a behavior or activity such as consuming alcohol, drug or other abusive subject, self-injuring behavior, abstaining from eating particular foods, angry or violent behavior, spending behaviors or any other behavior to which a plan of behavior modification is directed. Instances of abstaining may or may not be consecutive. As used herein, the term “days of performing” means the number of days a user has performed any desired activity directed to or consistent with a plan of behavior modification. Examples include performing or adhering to an exercise program or regime, reading scriptures, engaging in healthful habits, spending quality time with loved-ones and engaging in behaviors intended to improve oneself physically or emotionally. Days of performing may or may not be consecutive.

As used herein, the term “instances of performing” means the number of times a user has performed any desired activity directed to or consistent with a plan of behavior modification. Examples include performing or adhering to an exercise program or regime. Instances of performing may or may not be consecutive.

As used herein the term “elastomeric compound” means a compound selected from the group consisting of silicone rubber, styrene-butadiene rubber, polybutadiene, polychloroprene butyl rubber, natural rubber, and partially vulcanized natural rubber.

As used herein the term “elastomeric bracelet” means a wrist-band, ankle band or other bracelet all or partially constructed from an elastomeric compound.

As used herein, the term “branding indicia” means logo, text or indicia or any coloring or marking differentiating the appearance of an elastomeric bracelet, including any features associated with product or company branding.

As used herein, the term “eligibility attainment criteria” means a metric indicating that an individual has met a goal, or is eligible for a prize, event, admission or recognition.

As used herein, the term “spending behaviors” shall refer to a pattern of spending money or using resources that is targeted by a behavior modification program.

As used herein, a “sliding component” means a component or attachment to an elastomeric bracelet device which may be moved along the bracelet to mark metric indicia (e.g., text or numeric text indicating quantities or numbers), and which stays securely in place during the activities of the user to provide a continuous and accurate measurement record.

As used herein, the “metric indicia” means a numerical marking or text on the elastomeric bracelet used to indicate a quantity or number which can be associated with a related behavior modification goal.

As used herein, the term “protrusion” means a structural component which projects or protrudes, e.g., a protrusion which obstructs to movement of a slidable component across the bracelet surface.

### BRIEF DESCRIPTION OF DRAWINGS

FIG. 1 shows one embodiment of a side view of an elastomeric behavior modification bracelet that measures a behavioral metric as worn by a user.

FIG. 2a shows an embodiment of a behavior modification bracelet that measures a single behavioral metric for a single behavior.

FIG. 2b shows an embodiment of a behavior modification bracelet that measures multiple behavioral metrics or multiple increments of a behavioral metric.

FIG. 2c shows an embodiment of a behavior modification bracelet that measures a single behavioral metric in multiple increments.

FIG. 2d shows an embodiment of a behavior modification bracelet which is reversible to increase the number of behavioral metrics or multiple increments of a behavioral metric that can be measured.

FIGS. 3a shows an embodiment of a sliding component for measuring behavioral metrics.

FIGS. 3b shows an embodiment of a sliding component for measuring behavioral metrics that is reversible.

### DETAILED DESCRIPTION OF EMBODIMENTS OF THE INVENTION

For the purpose of promoting an understanding of the present invention, references are made in the text hereof to embodiments of the universal offset connecting rod, only some of which are described herein. It should nevertheless be understood that no limitations on the scope of the invention are thereby intended. One of ordinary skill in the art will readily appreciate that modifications such as the dimensions of the elastomeric device and system components herein could be made from, alternate but functionally similar material(s), and the inclusion of additional elements are deemed readily apparent and obvious to one of ordinary skill in the art, and all equivalent relationships to those described in the written description do not depart from the spirit and scope of the present invention. Some of these possible modifications are mentioned in the following description. Therefore, specific details disclosed herein are not to be interpreted as limiting, but rather as a basis for the claims and as a representative basis for teaching one of ordinary skill in the art to employ the present invention in virtually any appropriately detailed apparatus or manner.

It should be understood that the drawings are not necessarily to scale, emphasis instead being placed upon illustrating the principles of the invention. In addition, in the embodiments depicted herein, like reference numerals in the various drawings refer to identical or near identical structural elements.

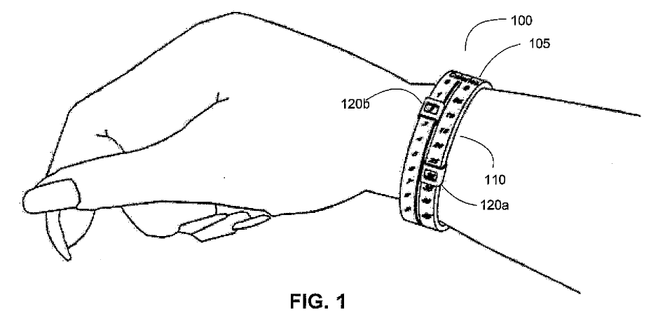

Referring now to the drawings, FIG. 1 is a side perspective view of one embodiment of an elastomeric bracelet for behavior modification bracelet with quantity indicators 100, as worn by a user. The embodiment shown, includes elastomeric bracelet 105, metric indicia 110 and sliding components 120a and 120b for marking metric indicia in 1,000, 100 and 5 calorie increments using two columns for metric indicia. In the embodiment shown, the behavioral metric being measured is calories. In other embodiments, calories may be counted in 100 calorie, 25 calorie, 10 calorie or five calorie increments, and may include fewer or more columns to measure various increments of the metric being tracked. In still other embodiments, the metric measured may be food grams, food portions, diet points (such as those used in the Weight Watchers® program), days or periods of abstention, days or periods of performance, budgeting metrics, exercise sessions or exercise related metrics, metrics related to compulsive or addictive behaviors or any other metric associated with a program or goal of behavior modification.

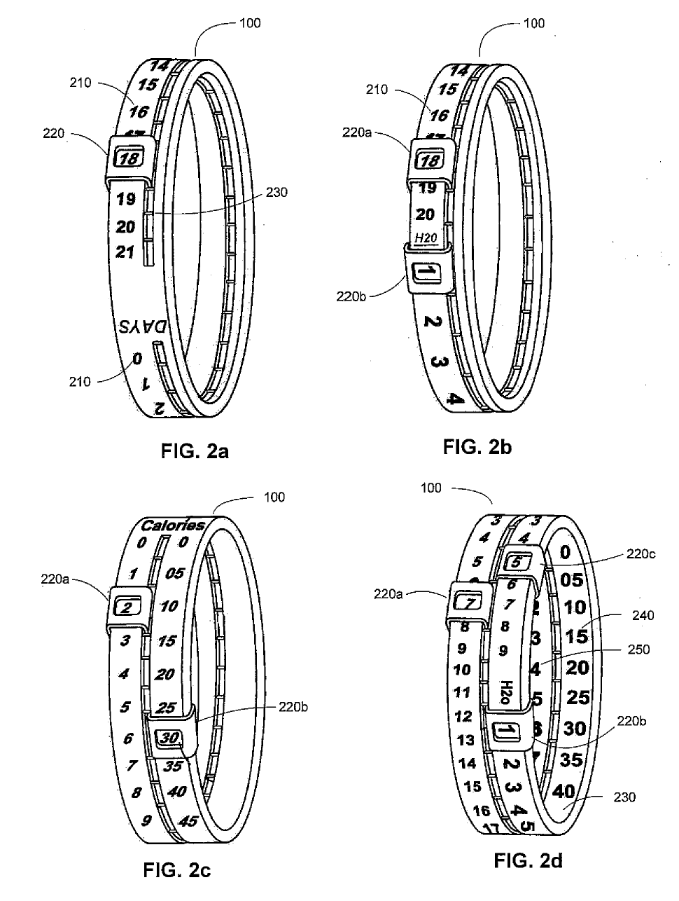

FIG. 2 illustrates several alternative embodiments of bracelet for behavior modification bracelet with quantity indicators 100, including FIG. 2a which illustrates an embodiment which tracks a single increment of a single behavioral metric using metric indicia 210 and sliding component 220. In embodiment shown protrusion 230 secures sliding component 220 in place during the normal activities of the wearer until the wearer deliberately moves the securing member (in this embodiment the protrusion is a slight bump). The embodiment shown appears as a bracelet having a single column.

FIG. 2b illustrates an embodiment of behavior modification bracelet with quantity indicators 100 using sliding components 220a and 220b which track multiple behavioral metrics (e.g., exercise sessions and grams) and/or increments simultaneously using a single metric indicia column 210. For example, the embodiment shown, in FIG. 2b the user is tracking both diet points and water consumption.

FIG. 2c illustrates a further embodiment which measures a single behavioral metric in multiple increments (e.g., thousands, hundreds, tens, fives and ones) with multiple sliding components (220a, 220b) using more than one column. For example, FIG. 2c shows a total of 230 calories consumed, in increments of hundreds and fives. FIG. 2c illustrates an embodiment with two columns with two sliding components 220a and 220b to represent a common metric (e.g. calories consumed).

FIG. 2d shows an embodiment of a behavior modification bracelet with quantity indicators 100 that measures behavioral metrics or multiple increments of behavioral metric with multiple sliding components 220a, 220b and 220c using more than one column, which further includes reversible surface 230 to track additional behaviors and/or increments 240 and 250.

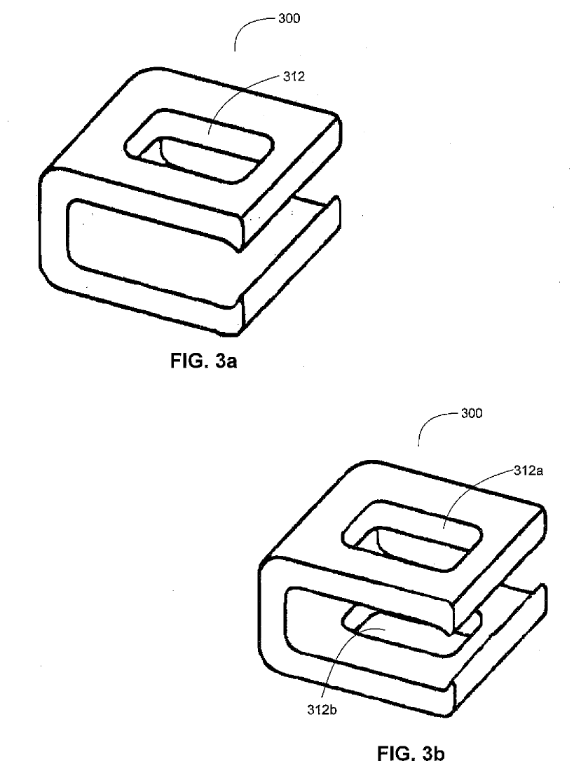

FIGS. 3a and 3b illustrate multiple embodiments of a sliding component 300 as shown in for behavior modification bracelet with quantity indicators 100. FIG. 3a is standard sliding component for a single window 312 to display metric indicia. FIG. 3b illustrates an embodiment of sliding component 300 which is reversible, having windows 312a and 312b.

What is claimed is:

1. A behavior modification bracelet with quantity indicator comprising:
a band having an outer major cylindrical surface;
at least one metric indicia visible on said outer major cylindrical surface and;
at least one sliding component for marking said at least one metric indicia.

2. The behavior modification bracelet of claim 1 which further includes a plurality of columns each containing at least one metric indicia.

3. The behavior modification bracelet of claim 1 which further includes at least one slidable component which is selectively positionable about said at least one metric indicia and which stays in a fixed position until subsequently moved.

4. The behavior modification bracelet of claim 3, wherein said outer major cylindrical surface further includes protrusions to secure said slidable component in place.

5. The behavior modification bracelet of claim 1 in which said at least one sliding component contains a viewable window portion.

6. The behavior modification bracelet of claim 1 wherein said band is made from a material selected from a group consisting of silicone rubber, styrene-butadiene rubber, polybutadiene, polychloroprene butyl rubber, natural rubber, and partially vulcanized natural rubber.

7. The behavior modification bracelet of claim 1 wherein said at least one metric indicia represents a metric selected from a group consisting of diet points, carbohydrates, calories, gram consumption, food point consumption, days of abstention, periods of abstention, days of performance, periods of performance, budgeting activity and exercise performed.

8. The behavior modification bracelet of claim 1 wherein said band contains branding indicia selected from the group consisting of a logo, text, indicia means, coloring and marking.

9. The behavior modification bracelet of claim 7 wherein abstention is related to a habit selected from a group consisting of smoking, drinking, overeating, binging, compulsive behavior and anger related behaviors.

10. The behavior modification bracelet of claim 1 wherein said at least one metric indicia is used to indicate a reward earned selected from a group consisting of a prize awarded, an admission to a facility and eligibility for a program.

11. A visible memory cue bracelet with quantity indicator comprising:
a band having an outer major cylindrical surface;
at least one metric indicia visible on said outer major cylindrical surface and;
at least one sliding component for marking said metric indicia.

12. The visible memory cue bracelet of claim 11 which further includes a plurality of columns each containing at least one metric indicia.

13. The visible memory cue bracelet of claim 11 which further includes at least one slidable component with is selectively positionable about said at least one metric indicia and which stays in a fixed position until subsequently moved.

14. The visible memory cue bracelet of claim 11 in which said at least one sliding component is removable.

15. The visible memory cue bracelet of claim 11 in which said at least one sliding component contains a viewable window portion.

16. The visible memory cue bracelet of claim 11 wherein said band is made from a material selected from a group consisting of silicone rubber, styrene-butadiene rubber, polybutadiene, polychloroprene butyl rubber, natural rubber, and partially vulcanized natural rubber.

17. The visible memory cue bracelet of claim 11 wherein said at least one metric indicia represents a metric selected from a group consisting of diet points, carbohydrates, calories, gram consumption, food point consumption, days of abstention, periods of abstention, days of performance, periods of performance, budgeting activity and exercise performed.

18. The visible memory cue bracelet of claim 11 wherein said band contains branding indicia selected from the group consisting of a logo, text, indicia means, coloring and marking.

19. The visible memory cue bracelet of claim 17 wherein abstention is related to a habit selected from a group consisting of smoking, drinking, overeating, binging, compulsive behavior and anger related behaviors.

20. A system of behavior modification comprising:
a behavior modification bracelet with quantity indicator comprising
a band comprising an outer major cylindrical surface;
at least one metric indicia;
at least one sliding component for marking said metric indicia;
and a reference tool for measuring a metric indicia.

21. The system of claim 20 wherein said reference tool is selected from the group consisting of a book, a CD, a pamphlet, an indexed guide to quantities, a website reference and a chart.
